(19) United States
(12) Patent Application Publication
(10) Pub. No.: US 2019/0387776 A1
(43) Pub. Date: Dec. 26, 2019

(54) SOLID POPCORN KERNEL-CONTAINING COMPOSITIONS

(71) Applicant: Soorholtz Farms, LLC, State Center, IA (US)

(72) Inventors: Kate Greer, Belvedere, CA (US); Brad Schulte, State Center, IA (US); Andrey Aryapetov, Brooklyn, NY (US)

(73) Assignee: Soorholtz Farms, LLC, State Center, IA (US)

(21) Appl. No.: 16/437,503

(22) Filed: Jun. 11, 2019

Related U.S. Application Data
(60) Provisional application No. 62/687,941, filed on Jun. 21, 2018.

(51) Int. Cl. A23L 7/183; A23L 33/115; A23P 30/10

(52) U.S. Cl. CPC A23L 7/183; A23V 2002/00; A23P 30/10; A23L 33/115

(57) ABSTRACT

A new delivery/storage method that combines all the necessary elements to make a healthy, optionally flavored cooked popcorn in a solid, shelf-stable unit that transforms on the stove to a bowl of warm popcorn. A solid fat and popcorn kernel mixture is formed into various shapes for cooking. Cocoa butter is tempered and combined with flavorants such as spices or flavored oils, to which popcorn kernels are added to provide a moldable composition. The solid popcorn kernel-containing compositions may be provided having various shapes and sizes such as balls, spheres, spherical/conical sections, disks, columns, and the like, which are readily transported and handled at room temperature for use in preparation of popcorn by cooking and consumption of popcorn after cooking.

This application claims the benefit of U.S. Provisional application No. 62/687,941 filed on Jun. 21, 2018, which is hereby incorporated by reference herein.

### FIELD OF THE INVENTION

A solid fat and popcorn kernel mixture is formed into various shapes for cooking. Cocoa butter is tempered and combined with flavorants such as spices or flavored oils, to which popcorn is added to provide a moldable composition. The solid popcorn kernel-containing compositions may be provided having various shapes and sizes such as balls, spheres, spherical/conical sections, disks, cylinders, columns, and the like, which are readily transported and handled at room temperature for use in preparation of popcorn by cooking and consumption of popcorn after cooking.

### BACKGROUND

Edible popcorn and popcorn products constitute a major market among U.S. consumers. Besides being an excellent low calorie snack, popcorn can also provide nutritional and health benefits. Popcorn products are eminently transportable.

The problem was the limited delivery of popcorn in the market currently: kernels only, pre-popped or microwave. A new portable, useful solid delivery system is needed.

Currently there are no known ways to create a solid pod that contains popcorn kernels, flavor and oil in one unit besides the invention described hereinbelow.

All of the existing products require either: a) a microwave and a bag containing a formula iii which the popcorn is popped and can only be done so in a microwave, b) a device that the formula must be contained in such as the tin foil pan that Jiffy Pop® uses to pop their popcorn over the stove, or c) a kit of multiple elements, instead of a solid unit pod containing all of the composition in one element.

### SUMMARY OF THE INVENTION

One objective of the present invention is to create a solid pod that contains a plurality of popcorn kernels, flavor and oil all in one unit. In an embodiment, a major oil component is cocoa butter and the flavor can include a flavoring oil or spice oil.

Another objective is to produce a popcorn kernel-containing solid useful for cooking, among other things, that is solid until about 97 degrees Fahrenheit, allows for a wide variety of flavors, uses a high quality oil for popping and controls the moisture for the popcorn.

In one embodiment, the invention relates to a formed, molded food composition including a plurality of popcorn kernels embedded and generally evenly dispersed in a solid fat matrix. The main component of the fat matrix comprises cocoa butter.

In a further embodiment, a method for making a food composition is described, including the steps of: providing cocoa butter, heating and tempering the cocoa butter (with or without one or more flavorants) to produce a tempered cocoa butter melt, adding dried popcorn kernels to a mold, pouring the tempered cocoa butter melt into the mold, and allowing the mold to cool to ambient temperature to produce a solid molded food composition (or “pod”).

The molded food composition can have many forms and fanciful shapes selected from balls, spheres, spherical/conical sections, disks, columns, cylinders, or the like.

Another embodiment comprises a method of using the solid molded food composition or pod to make popped optionally flavored popcorn.

### BRIEF DESCRIPTION OF THE DRAWINGS

FIG. 1 depicts a tempering curve for cocoa butter showing temperature over time in one embodiment, which is similar to that used for white chocolate.

FIG. 2 shows a photograph of a solid pod in accordance with an embodiment of the invention, which has a hemispherical shape. The solid pod contains popcorn kernels embedded in cocoa butter and flavorants. Scale is shown in inches,

FIG. 3 shows a photograph of a cylindrical solid pod in accordance with an embodiment of the invention. Scale is shown in inches.

FIG. 4 shows a photograph of a cylindrical puck-shaped solid pod or disk in accordance with an embodiment of the invention. Scale is shown in inches,

FIG. 5 shows a photograph of a pyramid shaped solid pod. Scale is shown in inches.

FIG. 6 shows a photograph of a solid pod having a braided configuration or shape. Scale is shown in inches.

FIG. 7 shows a photograph of a solid pod having a fanciful shape, i.e. a cat. Scale is shown in inches.

FIG. 8 shows a photograph of a cylindrical pod in accordance with an embodiment, having a weight of 89.5 grams. Popcorn kernel weight=59 grams.

FIG. 9 depicts a clear pot showing the popped popcorn resulting from cooking of the pod of FIG. 8, wherein the pot volume is 4 liters.

FIG. 10 shows the popped popcorn of FIG. 9 in a clear bowl, wherein the popcorn volume is about 4 cups (1 liter) and the yield is 76 grams.

### DETAILED DESCRIPTION

The present innovation is a new delivery/storage method that combines all the necessary elements to make a healthy, optionally flavored popcorn in a solid, shelf-stable unit that transforms by cooking on the stove to a bowl of warm popped popcorn.

All components of the finished product are edible and fit for human consumption and enjoyment. All components are generally safe for humans or other mammals based on UDSA standards.

As used herein, the term “popcorn” generally refers to the finished, that is, “fully” popped, product that is edible and generally fit for human consumption. It will be made clear by context when the popcorn is cooked or popped. Uncooked popcorn will generally be described using the term “popcorn kernels” while any generic use or interchangeability of terms will be made clear by context. It will be understood by those skilled in the art (not to mention consumers and users) that in most cases not every kernel in a cooked batch will be popped after heating or cooking. That is, 100% of popcorn kernels of a given popcorn kernel-containing composition will seldom be popped, and there will usually remain some unpopped kernels among the finished “fully popped” popcorn product batch. Thus the art and charm of making this traditional foodstuff.

In an embodiment, the present invention provides to the user a more efficient method for popping popcorn. Further, the present invention provides to the user a more portable and compact method for popping popcorn. Finally, the present invention provides to the user a more convenient method for popping popcorn.

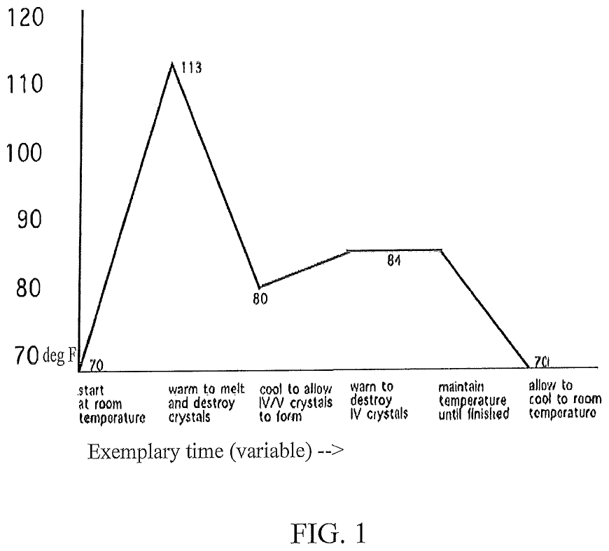

As used herein, the term “tempering” refers to a thermal production process whereby cocoa butter is treated in a similar fashion to that in chocolate production. For example, the temperature profile used to make white chocolate is particularly appropriate for use in the present invention, See, FIG. 1. Regarding the tempering timeline, the timing of each step varies quite widely depending on how one tempers, the quantity of the batch and the machinery employed. The whole process may be accomplished within 20 minutes, or may take hours, depending on the aforementioned variables, conditions, and the skill and experience of the operator or artisan.

The present solution involves the novel approach of tempering flavor-infused cocoa butter and combining with kernels to form into a solid in molds. The molded solids then melt over heat and pop into a bowl of cooked popcorn directly. Previously, there haven't been any exposed (i.e., “unwrapped” or unpackaged) solid units known to make popcorn, nor has this formulation of oils been used. Before this, it has only been accomplished in multi-element “kits” or in a contained bag—none of which use this specific oil or formulation and method of tempering to create a solid unit shape, or “pod.”

The individual pod can be provided in a 3-dimensional (3D) shape, such as, but not limited to, a ball, a sphere, an oblongated sphere (“football”), a half-sphere or hemisphere, a quarter-sphere or wedge, a cone, a spherical or conical section, a cylinder (or sections thereof), a column (or sections thereof), a disk, a box, a rectangle, and the like, or combinations thereof. Varied fanciful shapes are contemplated which would not necessarily have utility but would appeal to consumer preferences or contain company symbols, logos, or theatrical characters. Child consumers might prefer shapes in the form of letters, numbers, animals or other common objects. In fact, any useful 3D shape is contemplated for use in embodiments of the invention. Useful shapes of various types could be made using 3-D printing technology, casting, molding, injection molding, extrusion, candling, or the like.

Along these lines, the individual pod is solid and shelf-stable at ambient temperature. Another advantage is that the pods do not need to be contained in additional packaging. The pods are compact in shape and may be packed tightly for more efficient storage or display. Additionally, in a combination of all elements and features, the pods are aesthetically pleasing in shape(s) and appearance (e.g., in a “bath ball” type concept) for storage, display, or sale. For example, a combination of all of the elements and features into one unit can confer “bath ball” characteristics in the sense that the pod can be transformed by cooking into a useful popcorn product that is increased at least about 5× in volume and edible. In some embodiments the volume may be increased greater than 5×, for example, up to about 10× volume.

In its principal embodiment, this invention relates to a new delivery form for popping popcorn. Specifically, an innovative delivery method is described herein for providing and popping popcorn that uses a new oil and treatment process (tempering) in order to create a novel, shelf-stable pod that contains flavoring, a solid fat or oil, and popcorn kernels generally evenly dispersed in one solid unit.

In one embodiment, the invention is made by tempering the oil and infusing it with flavor oils. Then, combining with the popcorn kernels in molds to create a solid unit. That solid (until about 97 degrees Fahrenheit) is melted over medium heat on the stove in a covered pot to pop a flavored bowl of popcorn, which is about 5× the volume of the initial pod. Without further limitation, the pod can also be used in some other formats, e.g. popcorn popping machines, microwave. That is, in addition to the stovetop method of preparation, the pods work in many commercially available popcorn poppers and can also be used in the microwave if placed in the proper container.

In an embodiment, the formulation contains cocoa butter, high concentration oil or spice for flavoring (e.g., butter, rosemary, garlic, lemon, black pepper, vanilla, chipotle spice) and popcorn kernels. Using the method of tempering, the elements are combined to create a unitary solid pod with a melting point of approximately 97° F. The use for this unitary solid pod is to pop popcorn, primarily on the stove but there are additional applications of a microwave and other commercially available popcorn poppers.

The instant invention describes a novel method for creating popcorn “pods” by tempering (heating to a preferred temperature, then cooling, etc.) cocoa butter with additional flavoring oils and kernels to create a solid unit. The unit is then placed over heat, where the oil melts and then the popcorn pops. There are other formulations in existence that deliver flavor to popcorn during the popping process including Jiffy Pop® and microwave popcorn. However, the present composition does not need a pouch, bag, “pan” (as in the case of Jiffy Pop), or other container in order to use be used. Additionally, none of the other delivery methods are solid in form, that is, in the form of a unitary solid. In comparison, these other products contain loose ingredients and/or agglomerated pieces of ingredients.

A particularly useful solid fat/vegetable oil is cocoa butter (a.k.a. cacao butter or theobroma oil) derived from the cocoa beans of Theobroma cacao. Cocoa butter is the hard fat obtained from ripe cocoa seeds of Theobroma cacao. Cocoa seeds are then roasted in accordance with standard industrial and agricultural methods. After removal of the germ-roots and the shell from the seeds, by a process call “winnowing” the seeds are separated and crushed. The cocoa fat is squeezed out using various means including mechanical or automated means at a temperature of 70-80° C. and allowed to cool, thus producing cocoa butter. The main components of cocoa butter are triglycerides: (melting temperature range 31 to 35° C.) having as chief fatty acids oleic acid (33-39% by wt.), stearic acid (30-37% by wt.) , and palmitic acid (24-31% by wt.), among others. Alternatively, the cocoa butter may be separated mechanically, for example, in “raw” or minimally processed applications.

A preferred cocoa butter is available from Blommer Chocolate Company (Chicago, Ill.).

A useful fat composition of the invention can be interesterified (i.e., an acyl group of one ester is exchanged with that of another ester) chemically or enzymatically. Thus, acyl groups of the triacylglycerols (TAGs) in one vegetable oil can be exchanged or interchanged with acyl groups from another different vegetable oil or wax. Chemical interesterification generally is performed by first drying a blended fat and/or oil composition at about 105° C. to about 110° C. under vacuum for about 30 minutes to about 1 hour, then cooling to about 100° C., to about 105° C. Reactions are initiated by addition of catalyst, with development of an orange-brown color indicative of initiation of interesterification. Non-limiting examples of catalysts include base catalysts such as sodium methoxide, sodium ethoxide, sodium hydroxide, and glycerol. Metals such as sodium and magnesium, and metal hydrides also are useful catalysts.

Interesterification reactions typically are continued for 30 minutes to ensure completion. Progress of the reaction can be monitored using standard techniques such as differential scanning calorimetry (DSC), high performance liquid chromatography (HPLC), infrared spectrometry (IR), nuclear magnetic resonance spectroscopy (NMR), thin layer chromatography, Raman spectroscopy, or UV absorption. Upon completion of the reaction, catalysts such as sodium methoxide can be inactivated or quenched, for example, by addition of water, aqueous ammonium chloride, or citric acid, such as a 10% citric acid solution. Deactivated catalyst and soaps can be removed by a water wash, followed by centrifugation. The interesterified composition can be dried by addition of anhydrous magnesium sulfate or sodium sulfate, or dried at about 100° C. to about 105° C. under vacuum (e.g., <20 mmHg) for about 30 minutes.

Solid fat content (SFC): Solid fat contents can be measured using a Bruker Minispec NMR (Milton, Ontario, Canada), according to AOCS Official Method Cd 16b-93.

Components Contained in the Popcorn Kernel-Containing Formulation

The formulation contains popcorn (i.e. popcorn kernels) available from Soorholtz Farms (State Center, Iowa).

The solid fat components may include cocoa butter (a.k.a. cacao butter), available from Blommer Chocolate Company (Chicago, Ill.).

Other Fats

Mango butter may be used as a substitute for cocoa butter. Certain types of coconut oil may be used, or alternatively a mixture of oils may be substituted for the cocoa butter. However, these alternative oils would need to be kept at a lower temperature (i.e., refrigerated) or contained in a meltable cover or shell (e.g., M&M'S® candies).

Palm oil and palm stearin may be used. Other stearins are generally useful, including, but not limited to, coconut stearin, shea butter, and certain waxes. These components may be used in limited quantities as a finish, or in a blend for stability reasons.

Flavorants

The formulations may contain various flavoring components (“flavorants”), namely one or more of a flavoring oil, a spice oil, a spice, a flavor or flavoring extract, a salt (e.g. sodium chloride or table salt). The flavoring components can be added or incorporated according to taste and also function. Function is used in the sense that the solid compositions must remain moldable and transportable for easy use in cooking.

Exemplary spices and spice oils can include, but are not limited to, rosemary, garlic, black pepper, vanilla, chipotle spice, pumpkin, peppermint, curry, paprika, clove, cinnamon, jalapeño, thyme, cilantro, nutmeg, coffee, cumin, green tea, chai, lemongrass, marjoram, sage, sarsaparilla, sesame seed, spearmint, tarragon, white pepper, wintergreen, parsley, saffron, basil, dill, cardamom, oregano, cayenne, tamarind, chili pepper, fennel, mustard, coriander, star anise, turmeric, and the like.

Spice blends are contemplated including, but not limited to, Asian, Indian (including curry blends), Italian, Mexican, Moroccan, Thai (including curry), and the like, in order to introduce varied spicy, sweet, or savory flavor profiles.

Exemplary flavors, flavoring oils or extracts can include, but are not limited to, butter, almond, chocolate, lemon, orange, tangerine, banana, kaffir lime, lime, maple, onion, caramel, strawberry, cheese, bacon, pecan, peanut, barbeque, toffee, coconut, and the like. Spices and flavors are available from Primal Essence, Inc. (Oxnard, Calif.).

Sweeteners may include sugar (sucrose), molasses, honey, agave syrup, maple syrup, corn syrup, and the like. Non-nutritive or botanical sweeteners are contemplated, including, for example, luo han guo extract (monk fruit) or stevia.

Also contemplated in the embodiments of the present invention is the addition of other suitable and advantageous or complementary flavorings, colorants, herbs, herbal extracts, and nutraceuticals. The addition of other herbal extracts and nutraceuticals can add other beneficial effects, or help to increase or decrease the beneficial effects further in a desired direction. In addition, added herbal extracts and nutraceuticals can be used to balance strong beneficial effects, such as mental alertness and acuity with relaxation and anxiolytic properties. For example, the addition of citrulline malate would make the invention more suitable for athletes, whereas the addition of conjugated linoleic acid (CLAs) and/or propolmannan would make the product more suitable for those looking for weight management. Optionally, the addition of L-Carnosine, acetyl-L-Carnitine, and/or dimethylaminoethanol (DMAE) would optimize the product for senior citizens as it would protect against damage to muscle and organ proteins, a cumulative problem in the elderly.

Finishing can include additional flavor packets, sweeteners, toppings, add-ins or other finishes that can be added at the end of the process for making the finished popcorn. For example, a caramel pack may be included separately, in a kit, that can be poured over the popped bowl of popcorn. Other kits that include packets, toppings, or add-ins are contemplated.

The popcorn kernel-containing compositions and methods described above may be further Understood in connection with the following examples.

In an embodiment, the solid molded pod is kept separate from the heating element until the time it is ready to be cooked, for example, in a sealed pouch, container, wrapping or packaging. The packaging of the pod is sealed to maintain a certain moisture level (similar to how a chocolate bar is fresher and better if it stays wrapped) until the time that the pod is removed from the package and used with the heating element or apparatus (e.g. a bowl, pan, heated tray or countertop). The pod is removed from the package and placed into the heating apparatus at the time of cooking.

In an embodiment, a lid or some containing device must be used during the popping process to prevent injury.

The ratios of popcorn kernels to cocoa butter can be about 50:30 (wt./wt.) or about 40:20 (wt./wt.), for example. Preferred ranges of the components may include about 45 g to about 50 g popcorn kernels combined with about 30 g to about 35 g cocoa butter. The ratios of popcorn kernels to cocoa butter can range from about 80:30 (wt./wt.) to about 40:50 (wt./wt).

The preferred ranges provide about 1 quart (volumetric) of finished flavored popcorn. Smaller scale amounts (25 g) of popcorn kernels and larger scale amounts (150 g) were found to provide similar results generally using the same preferred ratios, while maintaining popcorn popping conversion (efficiency) and scaling to the final finished popcorn volume as expected, respectively.

The product and process described herein are performed using plain popcorn kernels embedded in a solid fat matrix. Thus, it is significant that the same results were found when no flavored oils or other additives were incorporated into the pod formulation. That is, the solid fat matrix may be flavored or unflavored.

For the popping process, an appropriately sized heating element or pan must be employed. Too small, or conversely too large of a pan can result in non-optimal results or process faults. The pan must be covered with a lid, but properly vented during cooking/popping. For example, the individual formed popcorn kernel-containing pod can be cooked at a medium temperature on a traditional gas or electric stove. However, if the heat applied is too high, burning of the product may result, but if too low, incorrect or incomplete popping (conversion). Popping can be improved by slight air venting using the lid and/or by agitating the pan occasionally and frequently to evenly disperse the kernels, but the aforementioned steps are not required. If desired, venting and/or agitation can be automated such that heat source, temperature gradient, air flow, and humidity are all electronically controlled and monitored.

When using a stove application, the user must listen for the popping to start and then slow, at which point the user removes the pan from the heat source but ensures that the pan remains covered for about 10 seconds more for optimal popping and product quality and flavor. Regarding the stove heating process, the pods may be used at almost all heat settings. Medium low to medium is the safest and most effective, but temperature settings from low to high were also shown to be effective for popping. “Medium” heating would be characterized at or above a temperature of about 97° F. to about 100° F., at which the solid fat of the pod melts.

Storage

The inventive solid pods are kept at ambient (room) temperature or slightly cooler. That is, the inventive solid pods may be handled and used at about “room temperature” of about 20° C. to about 25° C.

The popcorn kernels are dried to between 14-17% water moisture content for optimized popping. As for packaging, it is desirable for the pod to be contained and protected from sun, moisture, etc. which can be accomplished with a wide variety of container materials: papers, tin, glass, plastics, etc.

### EXAMPLE 1

Cocoa butter (30-35 g) is melted with 0.05 to 2.5% (by wt.) flavored oils to provide a cocoa butter melt. This oil combination is then tempered using the tempering time/temp. curve for white chocolate as shown in FIG. 1. Dry popcorn kernels (45-50 g) are poured into a mold which can have various shapes and sizes. Then, the tempered cocoa butter and flavored oil melt (i.e. molten) mixture is added to the mold and allowed to cool until set.

The formed pod is placed into a 1 qt. handled sauce pan on medium to medium low heat, covered with a standard pan lid, and evenly agitating and venting the lid during popping. The yield of popped flavored popcorn is about 1 quart (volumetric) and the finished flavored popcorn is placed in a 1 quart container for serving (or packaging).

### EXAMPLE 1A

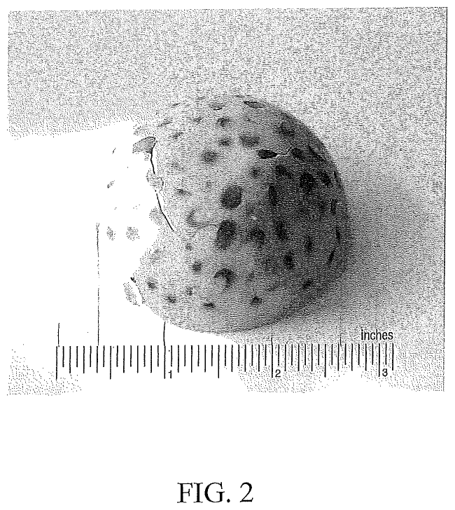

The previous Example 1 was carried out to provide a solid pod in the shape of a hemisphere as shown in FIG. 2. In this example the cocoa butter melt containing flavored oil was 25.51 g (29.03% by wt. of total pod). The final weight of the pod was 87.88 g and the diameter of the sphere was 6.985 cm.

### EXAMPLE 1B

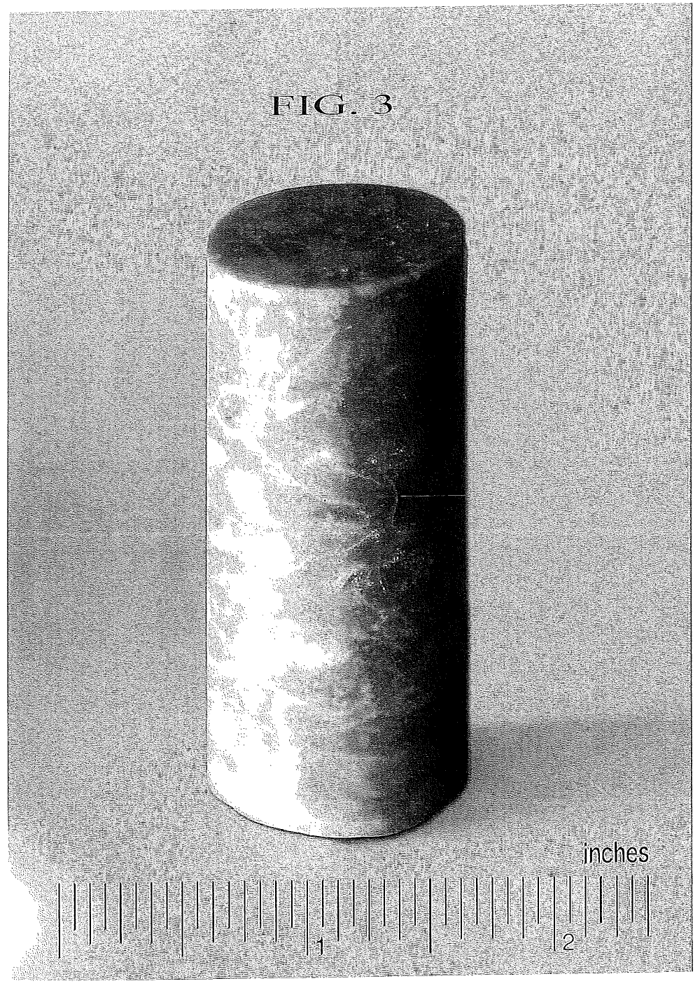

The previous Example 1 was carried out at an appropriate scale to provide a solid pod in the shape of a cylinder (solid cylindrical rod) as shown in FIG. 3. In this example the cocoa butter melt containing flavored oil was 14.79 g (29.81% by wt. of total pod). The final weight of the cylinder was 49.61 g and the diameter and height of the cylinder were 2.8 cm by 7.7 cm, respectively.

### EXAMPLE 1D

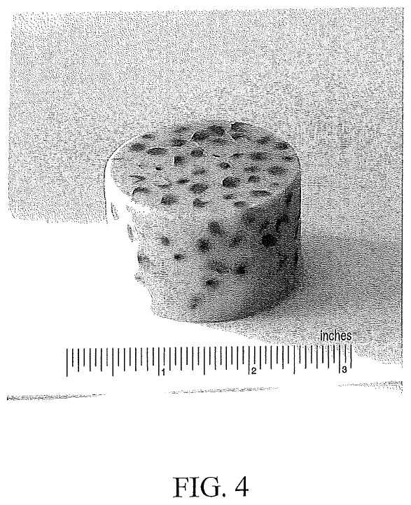

The previous Example 1 was carried out to provide a solid pod in the shape of a cylindrical disk as shown in FIG. 4. In this example the cocoa butter melt containing flavored oil was 28.35 g (31.25% by wt. of total pod). The final weight of the pod was 90.72 g and the diameter and height of the disk were 5.715 cm by 3.493 cm, respectively.

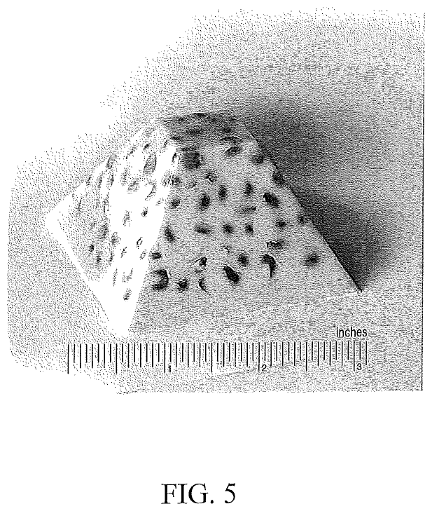

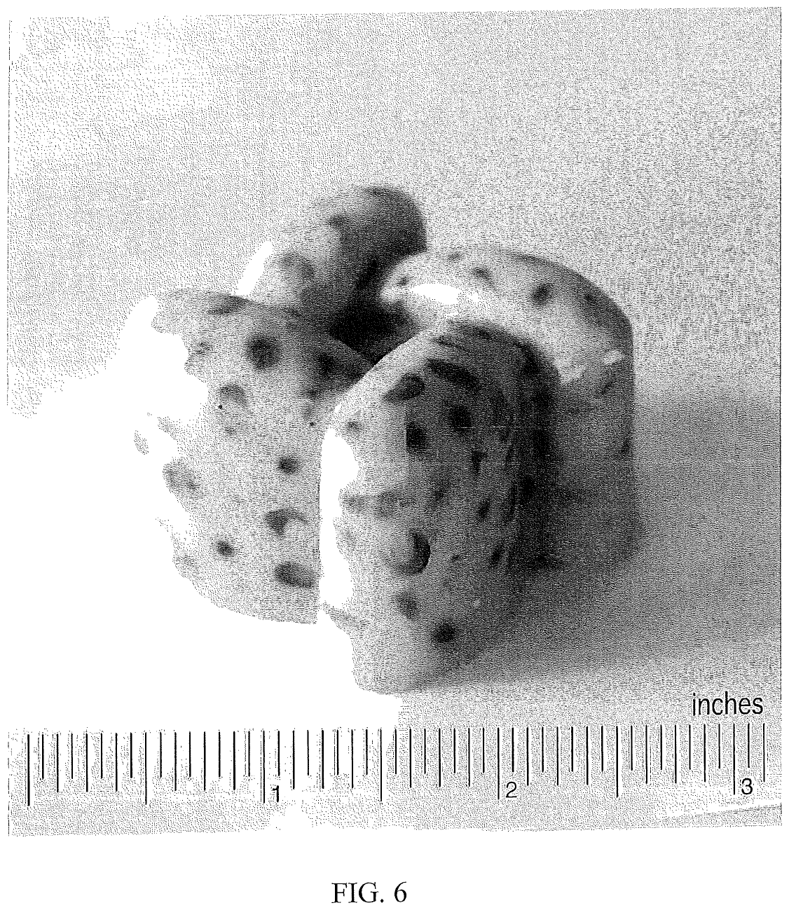

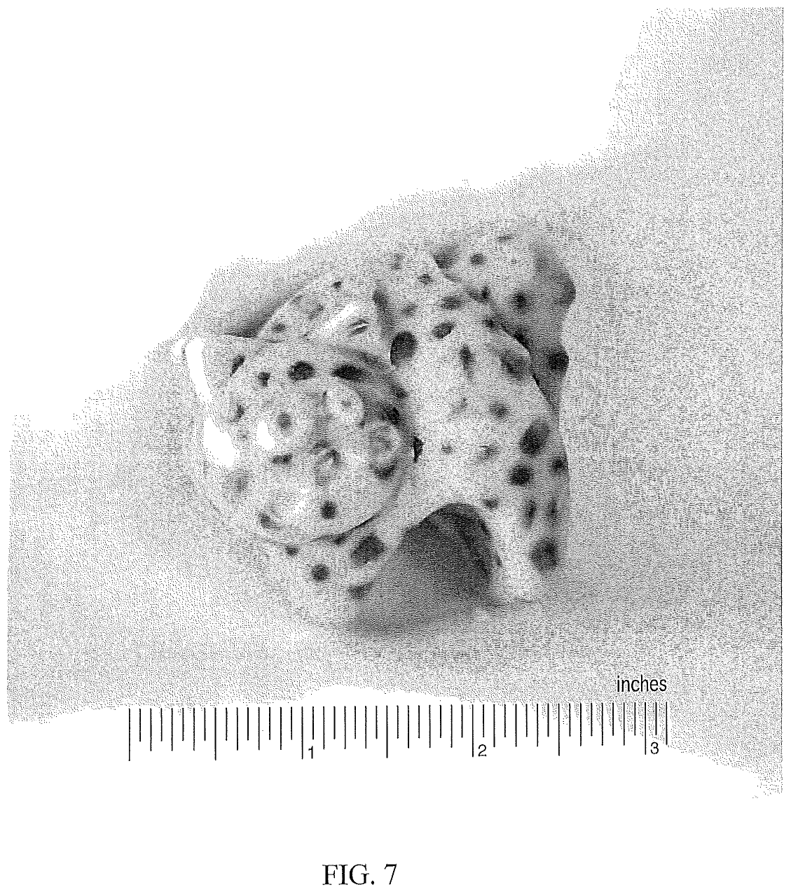

FIGS. 5-7 show solid pods having different shapes, including fanciful shapes (e.g., a cat). Other useful shapes are contemplated in accordance with molding techniques and the processing principles described herein.

### EXAMPLE 2

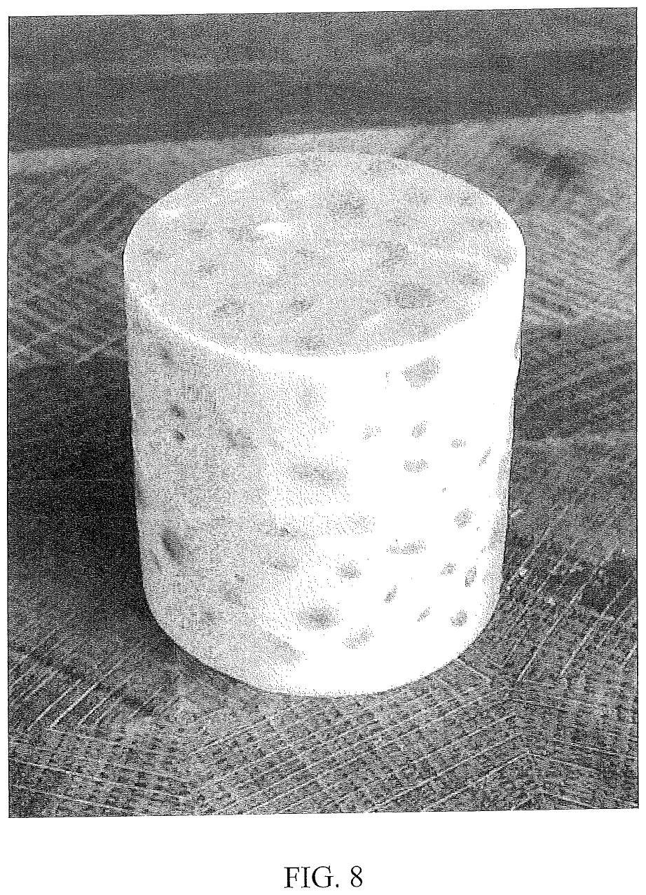

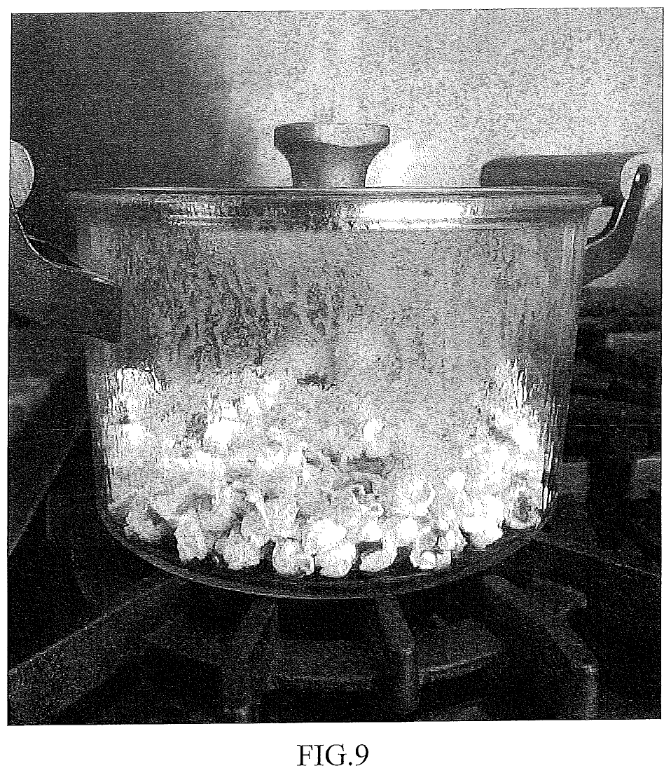

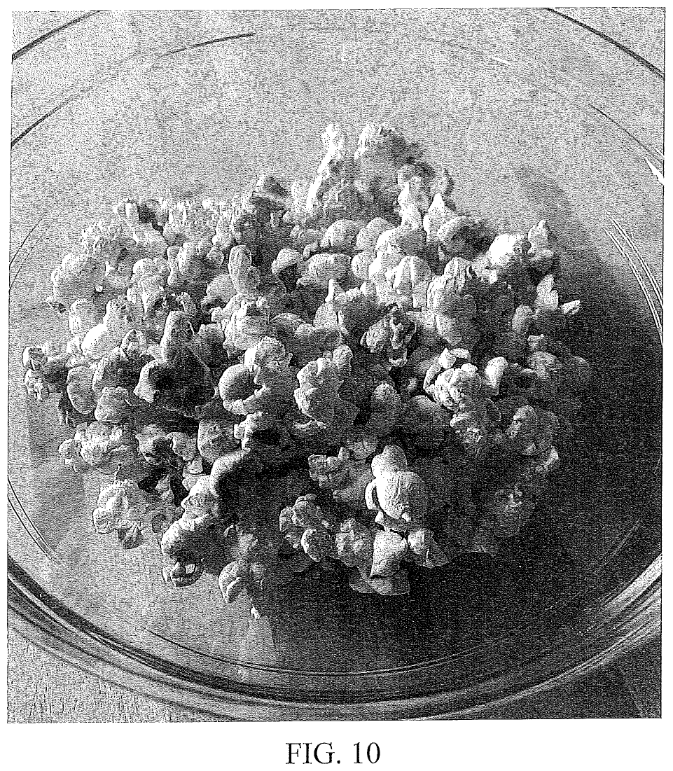

This example is performed by stove cooking in accordance with the above examples. Specifically, a formed cylindrical pod (89.5 g, kernel wt. 59 g) as shown in FIG. 8 is placed into a 4 liter handled sauce pan on medium to medium low heat, covered with a standard pan lid, and evenly agitating and venting the lid during popping. The yield of popped popcorn is about 1 liter (volumetric)=76 g, as shown in FIG. 9. The finished popcorn is placed in a container for serving (or packaging) as shown in FIG.10.

While in the foregoing specification this invention has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

All references cited herein are incorporated by reference in their entirety. The present invention may be embodied in other specific forms without departing from the spirit or essential attributes thereof and, accordingly, reference should be made to the appended claims, rather than to the foregoing specification, as indicating the scope of the invention.

We claim:

1. A formed food composition comprising a plurality of popcorn kernels, said kernels embedded and evenly dispersed in a solid fat matrix.

2. The formed food composition of claim 1, wherein the solid fat matrix comprises cocoa butter.

3. The formed food composition of claim 2, wherein the ratio of popcorn kernels to cocoa butter is from about 50:30 (wt./wt.) to about 40:20 (wt./wt.).

4. The formed food composition of claim 3, wherein the composition further comprises one or more flavorants selected from the group consisting of a flavoring oil, a spice oil, a spice, a flavor extract, and a flavoring extract.

5. The formed food composition of claim 3, wherein the composition further comprises a spice or spice oil selected from the group consisting of rosemary, garlic, black pepper, vanilla, chipotle spice, pumpkin, peppermint, curry, paprika, clover, cinnamon, star anise jalapeno, thyme, cilantro, nutmeg, coffee, cumin, green tea, chai, lemongrass, marjoram, sage, sarsaparilla, sesame seed, spearmint, tarragon, white pepper, wintergreen, parsley, saffron, basil, dill, cardamom, oregano, cayenne, tamarind, chili pepper, fennel, mustard, coriander, star anise, and turmeric in an amount from about 0.05% by wt, to about 2.5% by wt. based on the total weight of the composition.

6. The formed food composition of claim 3, wherein the composition further comprises a flavor oil or extract selected from the group consisting of butter, almond, chocolate, lemon, orange, tangerine, banana, kaffir lime, lime, maple, onion, caramel, strawberry, cheese, bacon, pecan, peanut, barbeque, coconut, and toffee in an amount from about 0.05% by wt. to about 2.5% by wt. based on the total weight of the composition.

7. A method for making a food composition, comprising the steps of:
(a) providing cocoa butter;
(b) heating the cocoa butter to about 100° F. until a melt is obtained;
(c) continuing heating the melt to about 113° F.;
(d) cooling the melt to about 80° F.;
(e) tempering the melt by heating to about 84° F. and maintaining the temperature for about 5 min, to produce a tempered cocoa butter melt;
(f) adding dried popcorn kernels to a mold;
(g) pouring the tempered cocoa butter melt into the mold; and
(h) allowing the mold to cool to ambient temperature to produce a solid molded food composition.

8. The process of claim 7, further comprising step (c1) following step (c):
(c1) adding a flavoring oil in an amount from about 0.05% by wt. to about 2.5% by wt. based on the total weight of the composition.
